(19) United States
(12) Patent Application Publication
(10) Pub. No.: US 2009/0264558 A1
(43) Pub. Date: Oct. 22, 2009

(54) Capped polyurethane prepolymers and heat-curable epoxy resin compositions

(75) Inventors: Andreas Kramer, Zurich (CH); Jurgen Finter, Zurich (CH); Urs Rheinegger, Zurich (CH); Jan Olaf Schulenburg, Zurich (CH)

Correspondence Address: OLIFF & BERRIDGE, PLC, P.O. BOX 320850, ALEXANDRIA, VA, 22320-4850, US

(73) Assignee: SIKA TECHNOLOGY AG, Baar (CH)

(21) Appl. No.: 12/311,046

(22) PCT Filed: Oct. 24, 2007
(86) PCT No.: PCT/EP2007/061416

§ 371 Date: Apr. 2, 2009

(30) Foreign Application Priority Data
Oct. 24, 2006 (EP) 06122863.1

(51) Int. Cl. C08L 63/00; C08G 18/10; C08L 75/04; B32B 37/12

(52) U.S. Cl. 523/400; 528/60; 525/403; 525/111; 524/500; 156/275.5

(57) ABSTRACT

The invention relates to differently blocked polyurethane polymers of formula, to their use as impact resistance modifiers, to heat-curable epoxy resin compositions containing said impact resistance modifiers and to methods for the production of said compositions. The invention also relates to bonding methods using said compositions and to articles produced by said methods.

### TECHNICAL FIELD

The invention relates to the field of impact modifiers and to the field of heat-curing epoxy resin compositions.

### PRIOR ART

Impact modifiers have a long history of use for improving the strength of adhesives subject to impact forces. Epoxy resin compositions in particular generally have high mechanical strengths but are very brittle, and this means that when the cured epoxy resin is subject to an impact force, for example one arising in a vehicle collision, it fractures, and the bond is therefore destroyed.

Liquid rubbers have a relatively long history of use as tougheners. Examples of liquid rubbers used are those based on acrylonitrile/butadiene copolymers, examples being obtainable as Hycar®.

EP-B-0 338 985 describes impact-resistant epoxy resin compositions which comprise not only liquid rubbers based on acrylonitrile/butadiene copolymers but also liquid rubbers based on polyurethane prepolymers, where these have capping by a phenol or by a lactam.

WO-A-2005/007766 discloses epoxy resin compositions which comprise a reaction product of a prepolymer capped by isocyanate groups and of a capping agent selected from the group of bisphenol, phenol, benzyl alcohol, aminophenol, or benzylamine. However, these epoxy resin compositions exhibit weaknesses in low-temperature impact resistance (<0° C.).

WO-A-03/093387 discloses impact-resistant epoxy resin compositions which comprise adducts of dicarboxylic acids with glycidyl ethers, or of bis(aminophenyl) sulfone isomers, or of aromatic alcohols, with glycidyl ethers. However, these compositions likewise have shortcomings in low-temperature impact resistance (<0° C.).

WO-A-2004/055092 and WO-A-2005/007720 disclose epoxy resin compositions with improved impact resistance, which comprise a reaction product of a polyurethane prepolymer terminated by isocyanate groups with a monohydroxyepoxide. These epoxy resin compositions have improved low-temperature impact resistance when compared with those comprising phenol-terminated polyurethane prepolymers, but are still not ideal.

### BRIEF DESCRIPTION OF THE INVENTION

It is therefore an object of the present invention to provide impact modifiers which, when compared with the impact modifiers known from the prior art, lead to improved impact resistances in epoxy resin compositions, in particular at low temperatures.

Surprisingly, it has been found that this can be achieved via end-capped polyurethane prepolymers as claimed in claim 1. Very surprisingly, it has been found that use of polyurethane prepolymers capped asymmetrically (i.e. using different capping agents) gives impact resistances that are higher than those obtained using polyurethane prepolymers known from the prior art, capped symmetrically (i.e. using identical capping agent).

The end-capped polyurethane prepolymers of the invention are used as impact modifiers in epoxy resin compositions.

The present invention therefore also provides heat-curing epoxy resin compositions as claimed in claim 11, which comprise at least one end-capped polyurethane prepolymer of the invention. These epoxy resin compositions have particularly high impact resistance not only at room temperature but also at low temperatures (−30° C. or −40° C.), and they are therefore particularly suitable as vehicle-bodyshell adhesives which perform particularly well in the event of a crash because they are impact-resistant.

### EMBODIMENTS OF THE INVENTION

The present invention firstly provides end-capped polyurethane prepolymers of the formula (I).

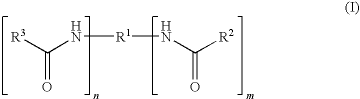

R¹ here is a linear or branched polyurethane prepolymer PU1 terminated by n+m isocyanate groups, after removal of all of the terminal isocyanate groups. The moieties R², independently of one another, are a capping group which is eliminated at a temperature above 100° C., or are a group of the formula (II), and the moieties R³, independently of one another, are a capping group which is eliminated at a temperature above 100° C., or are a group of the formula (II′).

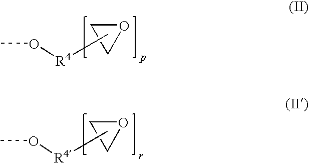

In each case here, R⁴ and R^{4′} is a moiety of an aliphatic, cycloaliphatic, aromatic, or araliphatic epoxide containing a primary or secondary hydroxy group, after the removal of the hydroxide and epoxide groups, and p is 1, 2, or 3, and f is 1, 2, or 3.

Finally, in each case n and m is a value from 1 to 7, with the proviso that 2≦(m+n)≦8. A further proviso is that R² differs from R³. The polyurethane prepolymer is therefore an “asymmetrically” capped prepolymer.

The expression “independently of the others” or “independently of one another” in the definition of R² and R³ means that among m groups R², and among n groups R³ it is not necessary that all of these are the same moiety, and instead they can have different meanings. In the extreme case, therefore, it is possible that the end-capped polyurethane prepolymer has 8 groups R² and R³ which differ from one another.

There are in principle very many types of possible capping groups R² and R³, and the person skilled in the art is aware of a wide range of these capping groups, for example from the review articles by Douglas A. Wick in Progress in Organic Coatings 36 (1999), 148-172, and in Progress in Organic Coatings 41 (2001), 1-83.

Particular moieties R² and/or R³ are moieties selected from the group consisting of

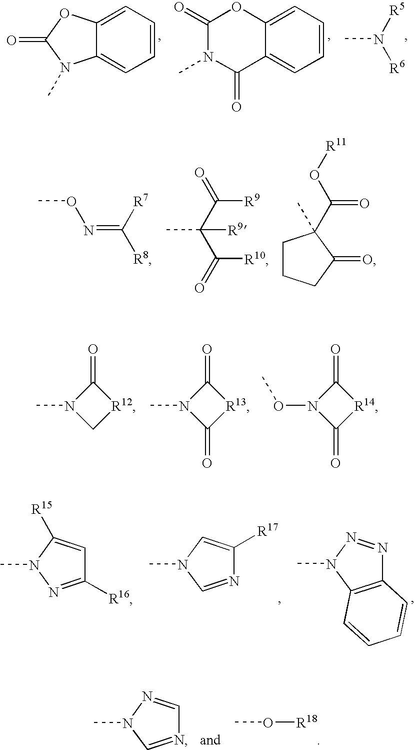

In each case here, R⁵, R⁶, R⁷ and R⁸, independently of the others, is either an alkyl or cycloalkyl or aryl or aralkyl or arylalkyl group, or R⁵ together with R⁶, or R⁷ together with R⁸, forms a portion of an optionally substituted 4- to 7-membered ring.

In each case, furthermore, R⁹, R^{9′}, and R¹⁰, independently of the others, is an alkyl or aralkyl or aryl or arylalkyl group, or is an alkyloxy or aryloxy or aralkyloxy group, and R¹¹ is an alkyl group.

In each case, furthermore, R¹², R¹³, and R¹⁴, independently of the others, is an alkylene group having from 2 to 5 carbon atoms and, if appropriate, having double bonds or substitution, or is a phenylene group, or is a hydrogenated phenylene group.

In each case, R¹⁵, R¹⁶, and R¹⁷, independently of the others, is H, or is an alkyl group, or is an aryl group or an aralkyl group, and R¹⁸ is an aralkyl group or is a mono- or polynuclear substituted or unsubstituted aromatic group which, if appropriate, has aromatic hydroxy groups.

The broken lines in the formulae in this document in each case represent the bond between the respective substituent and the associated molecular moiety.

Particular moieties that may be considered as R¹⁸ are firstly phenols or bisphenols after removal of a hydroxy group. Particular examples that may be mentioned of these phenols and bisphenols are phenol, cardanol (3-pentadecenylphenol (from cashew nut shell oil)), nonylphenol, bisphenol A, bisphenol F, and phenols reacted with styrene or with dicyclopentadiene.

Other particular moieties that may be considered as R¹⁸ are hydroxybenzyl alcohol and benzyl alcohol after removal of a hydroxy group.

If R⁵, R⁶, R⁷, R⁸, R⁹, R^{9′}, R¹⁰, R¹¹, R¹⁵, R¹⁶, or R¹⁷ is an alkyl group, this is in particular a linear or branched C₁-C₂₀-alkyl group.

If R⁵, R⁶, R⁷, R⁸, R⁹, R^{9′}, R¹⁰, R¹⁵, R¹⁶, R¹⁷, or R¹⁸ is an aralkyl group, this group is in particular an aromatic group bonded by way of methylene, in particular a benzyl group.

If R⁵, R⁶, R⁷, R⁸, R⁹, R^{9′}, or R¹⁰ is an alkylaryl group, this is in particular a C₁-C₂₀-alkyl group bonded by way of phenylene, examples being tolyl or xylyl.

The selection of the moieties R² and R³ is preferably such that the decapping temperatures of the capping groups R² and R³ differ markedly from one another. In particular, it is advantageous that the difference of the decapping temperatures of R² and R³ is at least 20° C., preferably at least 30° C. This permits controlled design of multistage crosslinking processes, providing access to a wide variety of possible adhesives.

It is also advantageous that the moieties R² and R³ are of a different class, deriving from different groups, these being the groups indicated above. By way of example, it is advantageous to use firstly hydroxy-functional epoxides of the formula (II) or (II′) and phenols or secondly phenols and oxazolinones as capping agents. All other combinations of the capping agents described are, of course, also conceivable, as also are ternary or quaternary mixtures of capping agents.

In one most preferred embodiment, R² is a group of the formula (II).

The polyurethane prepolymer PU1 on which R¹ is based can be produced from at least one diisocyanate or triisocyanate, or else from a polymer Q_{PM} having terminal amino, thiol, or hydroxy groups, and/or from a polyphenol Q_{PP}, if appropriate having substitution.

In this entire specification, the prefix syllable “poly” in “polyisocyanate”, “polyol”, “polyphenol”, and “polymercaptan” designates molecules which formally contain two or more of the respective functional groups.

Suitable diisocyanates are aliphatic, cycloaliphatic, aromatic, or araliphatic diisocyanates, in particular commercially available products, such as methylene-diphenyl diisocyanate (MDI), hexamethylene diisocyanate (HDI), toluene diisocyanate (TDI), tolidine diisocyanate (TODI), isophorone diisocyanate (IPDI), trimethylhexamethylene diisocyanate (TMDI), 2,5- or 2,6-bis(isocyanatomethyl)bicyclo[2.2.1]heptane, naphthalene 1,5-diisocyanate (NDI), dicyclohexylmethyl diisocyanate (H₁₂MDI), p-phenylene diisocyanate (PPDI), m-tetramethylxylylene diisocyanate (TMXDI), etc., and also their dimers. Preference is given to HDI, IPDI, MDI or TDI.

Suitable triisocyanates are trimers or biurets of aliphatic, cycloaliphatic, aromatic, or araliphatic diisocyanates, in particular the isocyanurates and biurets of the diisocyanates described in the previous paragraph.

It is, of course, also possible to use suitable mixtures of di- or triisocyanates.

Particularly suitable polymers Q_{PM} having terminal amino, thiol, or hydroxy groups are polymers Q_{PM} having two or three terminal amino, thiol, or hydroxy groups.

The polymers Q_{PM} advantageously have an equivalent weight of from 300 to 6000, in particular from 600 to 4000, preferably from 700 to 2200, g/equivalent of NCO-reactive groups.

Suitable polymers Q_{PM} are polyols, such as the following commercially available polyols, or any desired mixtures thereof:

polyoxyalkylene polyols, also termed polyether polyols, where these are the polymerization product of ethylene oxide, propylene 1,2-oxide, butylene 1,2- or 2,3-oxide, tetrahydrofuran, or a mixture thereof, if appropriate polymerized with the aid of a starter molecule having two or three active H atoms, examples being water or compounds having two or three OH groups. The materials used can either be polyoxyalkylene polyols which have a low degree of unsaturation (measured according to ASTM D2849-69 and stated in milliequivalent of unsaturation per gram of polyol (mEq/g)), produced by way of example with the aid of what are known as double metal cyanide complex catalysts (abbreviated to DMC catalysts), or else polyoxyalkylene polyols having a higher degree of unsaturation, produced by way of example with the aid of anionic catalysts, such as NaOH, KOH, or alkali metal alcoholates. Particularly suitable materials are polyoxypropylenediols and -triols having a degree of unsaturation below 0.02 mEq/g and having a molecular weight in the range from 1000 to 30 000 daltons, polyoxybutylenediols and -triols, polyoxypropylenediols and -triols having a molecular weight of from 400 to 8000 daltons, and also the materials termed “EO-endcapped” (ethylene-oxide-endcapped) polyoxypropylenediols or -triols. The latter are specific polyoxy-propylene polyoxyethylene polyols obtained by, for example, using ethylene oxide to alkoxylate pure polyoxypropylene polyols after conclusion of the polypropoxylation reaction, so that the products have primary hydroxy groups;

hydroxy-terminated polybutadiene polyols, such as those produced via polymerization of 1,3-butadiene and allyl alcohol or via oxidation of polybutadiene, and also their hydrogenation products;

styrene-acrylonitrile-grafted polyether polyols, such as those supplied as Lupranol® by Elastogran;

polyhydroxy-terminated acrylonitrile/butadiene copolymers such as those obtainable from carboxy-terminated acrylonitrile/butadiene copolymers (available commercially as Hycar® CTBN from Nanoresins AG, Germany) and from epoxides or amino alcohols;

polyester polyols produced by way of example from di- to trihydric alcohols, such as 1,2-ethanediol, diethylene glycol, 1,2-propanediol, dipropylene glycol, 1,4-butanediol, 1,5-pentanediol, 1,6-hexanediol, neopentyl glycol, glycerol, 1,1,1-trimethylolpropane, or a mixture of the abovementioned alcohols, using organic dicarboxylic acids or their anhydrides or esters, examples being succinic acid, glutaric acid, adipic acid, suberic acid, sebacic acid, dodecanedicarboxylic acid, maleic acid, fumaric acid, phthalic acid, isophthalic acid, terephthalic acid, and hexahydrophthalic acid, or a mixture of the above-mentioned acids, and also polyester polyols derived from lactones, such as ε-caprolactone;

polycarbonate polyols, such as those obtainable via reaction, for example, of the abovementioned alcohols—used in the structure of the polyester polyols—with dialkyl carbonates, with diaryl carbonates, or with phosgene.

The polymers Q_{PM} are advantageously at least dihydric polyols having OH-equivalent weights of from 300 to 6000 g/OH-equivalent, in particular from 600 to 4000 g/OH-equivalent, preferably from 700 to 2200 g/OH-equivalent. Further advantageous polyols are those selected from the group consisting of polyethylene glycols, polypropylene glycols, polyethylene glycol-polypropylene glycol block copolymers, polybutylene glycols, hydroxy-terminated polybutadienes, hydroxy-terminated butadiene/acrylonitrile copolymers, hydroxy-terminated synthetic rubbers, their hydrogenation products, and mixtures of the abovementioned polyols.

Other polymers Q_{PM} that can also be used are at least difunctional amino-terminated polyethylene ethers, polypropylene ethers, such as those marketed as Jeffamine® by Huntsman, polybutylene ethers, polybutadienes, butadiene/acrylonitrile copolymers such as those marketed as Hycar® ATBN by Nanoresins AG, Germany, and also other amino-terminated synthetic rubbers or mixtures of the components mentioned.

For certain applications, particularly suitable polymers Q_{PM} are hydroxylated polybutadienes or polyisoprenes, or their partially or completely hydrogenated reaction products.

It is moreover possible that the polymers Q_{PM} can also have been chain-extended, in the manner known to the person skilled in the art, via the reaction of polyamines, polyols, and polyisocyanates, in particular of diamines, diols, and diisocyanates.

Taking the example of a diisocyanate and a diol, the product is, as shown below, as a function of the selected stoichiometry, a species of the formula (VI) or (VII)

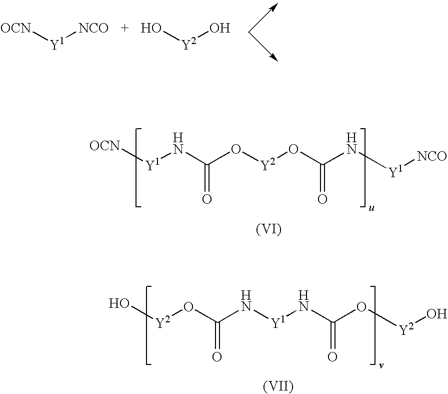

The moieties Y¹ and Y² are a divalent organic moiety, and the indices u and v vary from 1 to, typically, 5 as a function of the stoichiometric ratio.

These species of the formula (VI) or (VII) can then in turn be further reacted. By way of example, a chain-extended polyurethane prepolymer PU1 of the following formula can be formed from the species of the formula (VI) and from a diol using a divalent organic moiety Y³:

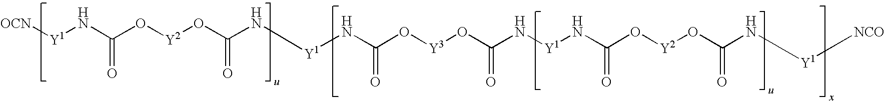

A chain-extended polyurethane prepolymer PU1 of the following formula can be formed from the species of the formula (VII) and from a diisocyanate using a divalent organic moiety Y⁴:

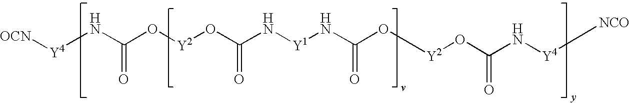

The indices x and y vary from 1 to, typically, 5 as a function of the stoichiometric ratio, and in particular are 1 or 2.

The species of the formula (VI) can moreover also be reacted with the species of the formula (VII), thus producing a chain-extended polyurethane prepolymer PU1 having NCO groups.

For the chain extension reaction, particular preference is given to diols and/or diamines and diisocyanates. The person skilled in the art is, of course, aware that it is also possible to use higher-functionality polyols, such as trimethylolpropane or pentaerythritol, or higher-functionality polyisocyanates, such as isocyanurates of diisocyanates, for the chain extension reaction.

In the case of the polyurethane prepolymers PU1 generally, and in the case of the chain-extended polyurethane prepolymers specifically, it is advantageous to ensure that the prepolymers do not have excessive viscosities, particularly if higher-functionality compounds are used for the chain extension reaction, because this can create difficulties in their reaction to give the polymers of the formula (I), or in the application of the composition.

Preferred polymers Q_{PM} are polyols having molecular weights of from 600 to 6000 daltons, selected from the group consisting of polyethylene glycols, polypropylene glycols, polyethylene glycol-polypropylene glycol block polymers, polybutylene, glycols, hydroxy-terminated polybutadienes, hydroxy-terminated butadiene-acrylonitrile copolymers, and also their mixtures.

Particularly preferred polymers Q_{PM} are α,ω-dihydroxypolyalkylene glycols having C₂-C₆-alkylene groups or having mixed C₂-C₆-alkylene groups, and having termination by amino, thiol, or, preferably, hydroxy groups. Particular preference is given to polypropylene glycols or polybutylene glycols. Particular preference is further given to polyoxybutylenes terminated by hydroxy groups.

Bis-, tris-, and tetraphenols are particularly suitable as polyphenol Q_{PP}. This not only means unsubstituted phenols but also, if appropriate, means substituted phenols. The nature of the substitution can be very varied. This in particular means substitution directly on the aromatic ring bonded to the phenolic OH group. Phenols here are moreover not only mononuclear aromatics but are also polynuclear or condensed aromatics or heteroaromatics, which have the phenolic OH group directly on the aromatic or heteroaromatic system.

The nature and position of this type of substituent is one of the factors influencing the reaction with isocyanates necessary for the formation of the polyurethane prepolymer PU1.

The bis- and trisphenols are particularly suitable. Examples of suitable bisphenols or trisphenols are 1,4-dihydroxybenzene, 1,3-dihydroxybenzene, 1,2-dihydroxybenzene, 1,3-dihydroxytoluene, 3,5-dihydroxybenzoates, 2,2-bis(4-hydroxyphenyl)propane (=bisphenol A), bis(4-hydroxyphenyl)methane (=bisphenol F), bis(4-hydroxyphenyl) sulfone (=bisphenol S), naphthoresorcinol, dihydroxynaphthalene, dihydroxyanthraquinone, dihydroxybiphenyl, 3,3-bis(p-hydroxyphenyl) phthalides, 5,5-bis(4-hydroxyphenyl)hexahydro-4,7-methanoindane, phenolphthaleine, fluorescein, 4,4′-[bis(hydroxyphenyl)-1,3-phenylenebis(1-methylethylidene)] (=bisphenol M), 4,4′-[bis(hydroxyphenyl)-1,4-phenylenebis(1-methylethylidene)] (=bisphenol P), 2,2′-diallylbisphenol A, diphenols and dicresols produced via reaction of phenols or of cresols with diisopropylidenebenzene, phloroglucinol, gallic esters, phenol novolac, respectively, cresol novolac having OH-functionality of from 2.0 to 3.5, and also all of the isomers of the abovementioned compounds.

Preferred diphenols and dicresols produced via reaction of phenols or cresols with diisopropylidenebenzene have the type of chemical structural formula shown accordingly below for cresol as example:

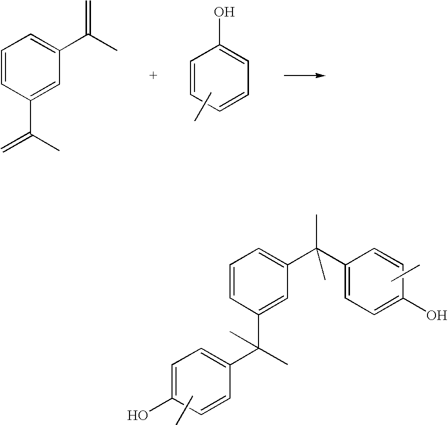

Particular preference is given to low-volatility bisphenols. Most preference is given to bisphenol M, bisphenol S, and 2,2′-diallylbisphenol A.

The Q_{PP} preferably has 2 or 3 phenolic groups.

In one first embodiment, the polyurethane prepolymer PU1 is produced from at least one diisocyanate or triisocyanate, and also from a polymer Q_{PM} having terminal amino, thiol, or hydroxy groups. The polyurethane prepolymer PU1 is produced in a manner known to the person skilled in the art of polyurethanes, in particular by using the diisocyanate or triisocyanate in a stoichiometric excess, based on the amino, thiol, or hydroxy groups of the polymer Q_{PM}.

In a second embodiment, the polyurethane prepolymer PU1 is produced from at least one diisocyanate or triisocyanate and also from a polyphenol Q_{PP}, which, if appropriate, has substitution. The polyurethane prepolymer PU1 is produced in a manner known to the person skilled in the art of polyurethanes, in particular by using the diisocyanate or triisocyanate in a stoichiometric excess, based on the phenolic groups of the polyphenol Q_{PP}.

In a third embodiment, the polyurethane prepolymer PU1 is produced from at least one diisocyanate or triisocyanate, and also from a polymer Q_{PM} having terminal amino, thiol, or hydroxy groups, and also from a polyphenol Q_{PP} which, if appropriate, has substitution. Various possibilities are available for production of the polyurethane prepolymer PU1 from at least one diisocyanate or triisocyanate, and also from a polymer Q_{PM} having terminal amino, thiol, or hydroxy groups, and/or from a polyphenol Q_{PP} which, if appropriate, has substitution.

In a first process, termed “one-pot process”, a mixture of at least one polyphenol Q_{PP} and of at least one polymer Q_{PM} is reacted with at least one diisocyanate or triisocyanate, using an excess of isocyanate.

In a second process, termed “2-step process I”, at least one polyphenol Q_{PP} is reacted with at least one diisocyanate or triisocyanate, using an excess of isocyanate, and this is followed by reaction with a substoichiometric amount of at least one polymer Q_{PM}.

Finally, in the third process, termed “2-step process II”, at least one polymer Q_{PM} is reacted with at least one diisocyanate or triisocyanate, using an excess of isocyanate, and this is followed by reaction with a substoichiometric amount of at least one polyphenol Q_{PP}.

The three processes lead to isocyanate-terminated polyurethane prepolymers PU1 which can differ in the sequence of their units, even if they have the same constitution. All three processes are suitable, but preference is given to “2-step process II”.

If the isocyanate-terminal polyurethane prepolymers PU1 described are composed of difunctional components, it was found that the polymer Q_{PM}/polyphenol Q_{PP} equivalent ratio is preferably greater than 1.50 and that the polyisocyanate/(polyphenol Q_{PP}+polymer Q_{PM}) equivalent ratio is preferably greater than 1.20.

If the average functionality of the components used is greater than 2, the molecular-weight increase that takes place is more rapid than in the purely difunctional case. It is clear to the person skilled in the art that the limits of the possible equivalent ratios are highly dependent on whether either the selected polymer Q_{PM}, the polyphenol Q_{PP}, or the polyisocyanate, or a plurality of the components mentioned, has/have a functionality >2. Various equivalent ratios can be set; the limits of these are determined via the viscosity of the resultant polymers, and the ratios have to be determined experimentally for each individual case.

The polyurethane prepolymer PU1 preferably has elastic character; its glass transition temperature Tg is below 0° C.

The end-capped polyurethane prepolymer of the formula (I) can be produced from a polyurethane prepolymer PU1 having isocyanate groups and having the formula (III), and from the NCO-reactive compounds R²—H and R³—H.

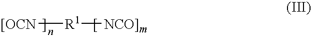

The polyurethane prepolymer PU1 having isocyanate groups here can be reacted with a mixture of R²—H and R³—H, or a sequential reaction can take place by way of an intermediate of the formula (IVa) or (IVb).

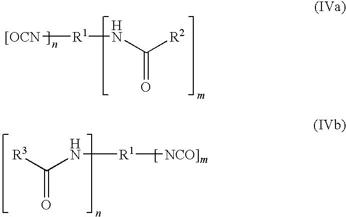

In a second step, this intermediate of the formula (IVa) containing NCO groups is then reacted with R³H, or this intermediate of the formula (IVb) containing NCO groups is then reacted with R²H, to give the end-capped polyurethane prepolymer of the formula (I). An advantage of this sequential reaction is that the reaction can be better controlled, thus reducing formation of symmetric adducts (“symmetrical” capping). This is particularly advantageous when the NCO reactivities of the compounds R²—H and R³—H are very different.

In one preferred embodiment, in which R² is the group of the formula (II), the corresponding reaction of the polyurethane prepolymer PU1 having the formula (III) takes place using a monohydroxyepoxide compound of the formula (V) and using a capping agent R³—H.

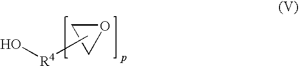

In the case of a sequential reaction, which is again preferred here, an intermediate of the formula (IVb) or of the formula (IVc) is produced

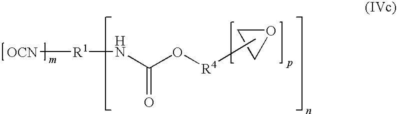

It is preferable that the end-capped polyurethane prepolymer of the formula (I) is produced by way of the intermediate of the formula (IVc).

This sequential reaction can firstly be used for direct formation of the capped polyurethane prepolymer of the formula (I), which is then used in the preparation of the epoxy resin composition.

Secondly, the sequential reaction can also be used in a specific embodiment as described below. The intermediate obtained in the first step of the sequential reaction, i.e. the partially capped prepolymer of the formula (IVa) or (IVb), in particular of the formula (IVc), can thus be further mixed with the further constituents of a heat-curing epoxy resin composition as described in detail at a subsequent point in this document, and be used in the manufacture of a preliminary product which is transportable and which is storable at room temperature with exclusion of moisture. At a subsequent juncture, prior to application, the appropriate compound R²H or R³H can be incorporated by mixing into the preliminary product, for example with the aid of an extrusion process, thus leading in situ within the composition to the formation of the capped polyurethane prepolymer of the formula (I). One specific example of this is the production of a semifinished product which comprises at least one epoxy resin A and at least one partially capped prepolymer of the formula (IVc), and also at least one hardener B for epoxy resins, where the hardener is activated via an elevated temperature. Details concerning these ingredients and further possible ingredients are described at a later stage in this document. This semifinished product is storable and can, at a later juncture, be metered into, and admixed with, a liquid epoxy resin, or into a composition comprising this type of resin, for example again with the aid of an extrusion process, at a temperature below the activation temperature of the hardener B. The liquid epoxy resin comprises, as mentioned below, a monohydroxyepoxide compound of the formula (IX), which corresponds to the compound R³H and, respectively, to a monohydroxyepoxide compound of the formula (V′)

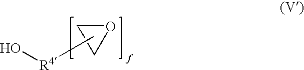

The end-capped polyurethane prepolymer of the formula (I) is thus produced in situ from the partially capped prepolymer of the formula (IVc) and from the monohydroxyepoxide compound of the formula (V′). The specific example described here of a heat-curing epoxy resin composition can then be used as adhesive or as what is known as reinforcer for the reinforcement of sheet-metal structures or, respectively, tubular structures in vehicle construction, in that the hardening process takes place at a temperature above the activation temperature of the hardener B.

The monohydroxyepoxide compound of the formula (V) or of the formula (V′) has 1, 2, or 3 epoxide groups. The hydroxy group of this monohydroxyepoxide compound (V) or of the formula (V′) can be a primary or secondary hydroxy group.

These monohydroxyepoxide compounds can by way of example be produced via reaction of polyols with epichlorohydrin. As a function of the conduct of the reaction of polyhydric alcohols with epichlorohydrin, the corresponding monohydroxyepoxide compounds are also produced as by-products at various concentrations. These can be isolated via conventional separation operations. However, it is generally possible simply to use the product mixture obtained in the glycidylization reaction of polyols and composed of polyol reacted completely or partially to give the glycidyl ether. Examples of these hydroxylated epoxides are butanediol monoglycidyl ether (present in butanediol diglycidyl ether), hexanediol monoglycidyl ether (present in hexanediol diglycidyl ether), cyclohexanedimethanol glycidyl ether, trimethylolpropane diglycidyl ether (in the form of mixture present in trimethylolpropane triglycidyl ether), glycerol diglycidyl ether (in the form of mixture present in glycerol triglycidyl ether), pentaerythritol triglycidyl ether (in the form of mixture present in pentaerythritol tetraglycidyl ether). It is preferable to use trimethylolpropane diglycidyl ether, a relatively high proportion of which occurs in conventionally produced trimethylolpropane triglycidyl ether.

However, it is also possible to use other similar hydroxylated epoxides, in particular glycidol, 3-glycidyloxybenzyl alcohol, or hydroxymethylcyclohexene oxide. Preference is further given to the β-hydroxy ether of the formula (IX), which is present to an extent of about 15% in commercially available liquid epoxy resins produced from bisphenol A (R=CH₃) and epichlorohydrin, and also the corresponding β-hydroxy ethers of the formula (IX) which are formed during the reaction of bisphenol F (R=H) or of the mixture of bisphenol A and bisphenol F with epichlorohydrin.

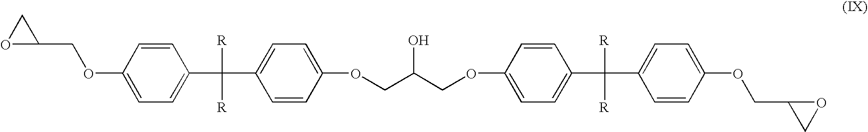

Preference is also further given to distillation residues produced during the production of high-purity, distilled liquid epoxy resins. These distillation residues have from one to three times higher concentration of hydroxylated epoxides when compared with commercially available undistilled liquid epoxy resins. It is also possible below to use a very wide variety of epoxides having a β-hydroxy ether group, produced via the reaction of (poly)epoxides with a substoichiometric amount of monofunctional nucleophiles, such as carboxylic acids, phenols, thiols, or secondary amines.

The free primary or secondary OH-functionality of the monohydroxyepoxide compound of the formula (V) permits efficient reaction with terminal isocyanate groups of prepolymers, without any need here to use disproportionate excesses of the epoxide component.

Overall, stoichiometric amounts of R³H, and in particular of the monohydroxyepoxide compound of the formula (V), and R²H can be used for the reaction of the polyurethane prepolymers PU1 of the formula (III). If a sequential reaction is carried out, with formation of the intermediate of the formula (IVa), (IVb), or (IVc), it can be advantageous to use a stoichiometric excess of the compound R³H or R²H used in the second step, in order to ensure that all of the NCO groups are consumed in the reaction.

The end-capped polyurethane prepolymer of the formula (I) advantageously has elastic character and is further advantageously dispersible or soluble in liquid epoxy resins.

It has been found that the end-capped polyurethane prepolymer of the formula (I) can give excellent results when used as impact modifier, in particular in epoxy resins.

The present invention also provides heat-curable epoxy resin compositions which comprise
at least one epoxy resin A having an average of more than one epoxide group per molecule;
at least one end-capped polyurethane prepolymer of the formula (I) described above, and also
at least one hardener B for epoxy resins, where this hardener is activated via an elevated temperature.

The epoxy resin A having an average of more than one epoxide group per molecule is preferably a liquid epoxy resin or a solid epoxy resin. The term “solid epoxy resin” is very well known to the person skilled in the art of epoxy resins, and is used in contrast to “liquid epoxy resins”. The glass transition temperature of solid resins is above room temperature, i.e. they can be comminuted at room temperature to give flowable powders.

Preferred solid epoxy resins have the formula (X)

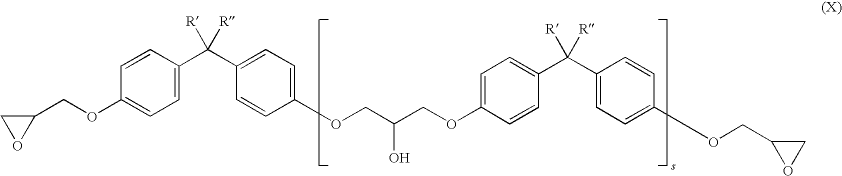

The substituents R′ and R″ here, independently of one another, are either H or CH₃. The index s is moreover a value >1.5, in particular from 2 to 12.

Solid epoxy resins of this type are commercially available, for example from Dow or Huntsman, or Hexion.

Compounds of the formula (X) having an index s from 1 to 1.5 are termed semisolid epoxy resins by the person skilled in the art. For this invention, they are likewise considered to be solid resins. However, preference is given to epoxy resins in the narrower sense, i.e. where the index s has a value >1.5.

Preferred liquid epoxy resins have the formula (XI)

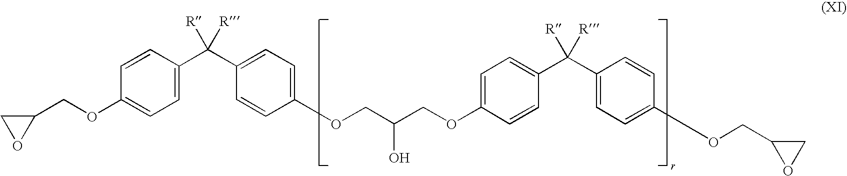

The substituents R′″ and R″″ here, independently of one another, are either H or CH₃. The index r moreover is a value from 0 to 1. r is preferably a value smaller than 0.2.

These materials are therefore preferably diglycidyl ethers of bisphenol A (DGEBA), of bisphenol F, or else of bisphenol A/F (where the term “A/F” here indicates a mixture of acetone with formaldehyde used as starting material in the production of this material). Liquid resins of this type are available by way of example in the form of Araldite® GY 250, Araldite® PY 304, Araldite® GY 282 (Huntsman) or D.E.R.™ 331 or D.E.R.™ 330 (Dow), or Epikote 828 (Hexion).

It is preferable that the epoxy resin A is a liquid epoxy resin of the formula (XI). In an embodiment to which even more preference is given, the heat-curing epoxy resin composition comprises at least one liquid epoxy resin of the formula (XI) but also at least one solid epoxy resin of the formula (X).

The proportion of epoxy resin A is preferably from 10 to 85% by weight, in particular from 15 to 70% by weight, with preference from 15 to 60% by weight, based on the weight of the composition.

The proportion of the end-capped polyurethane prepolymer of the formula (I) is preferably from 1 to 45% by weight, in particular from 3 to 30% by weight, based on the weight of the composition.

The composition of the invention further comprises at least one hardener B for epoxy resins, where this hardener is activated via an elevated temperature. The materials here are preferably a hardener selected from the group consisting of dicyandiamide, guanamines, guanidines, aminoguanidines, and their derivatives. It is also possible to use accelerating hardeners, e.g. substituted ureas, such as 3-chloro-4-methylphenylurea (chlortoluron), or phenyldimethylureas, in particular p-chlorophenyl-N,N-dimethylurea (monuron), 3-phenyl-1,1-dimethylurea (fenuron) or 3,4-dichlorophenyl-N,N-dimethylurea (diuron). It is also possible to use compounds of the class of the imidazoles and amine complexes.

It is preferable that the hardener B involves a hardener selected from the group consisting of dicyandiamide, guanamines, guanidines, aminoguanidines, and their derivatives; substituted ureas, in particular 3-chloro-4-methylphenylurea (chlortoluron), or phenyldimethylureas, in particular p-chlorophenyl-N,N-dimethylurea (monuron), 3-phenyl-1,1-dimethylurea (fenuron) or 3,4-dichlorophenyl-N,N-dimethylurea (diuron), and also imidazoles and amine complexes.

Dicyandiamide is particularly preferred as hardener B.

The total proportion of the hardener B is advantageously from 1 to 10% by weight, preferably from 2 to 8% by weight, based on the weight of the entire composition.

The heat-curing epoxy resin composition can further comprise an agent C having thixotropic effect, based on a urea derivative. The urea derivative is in particular a reaction product of an aromatic monomeric diisocyanate with an aliphatic amine compound. It is also fully possible that a plurality of different monomeric diisocyanates are reacted with one or more aliphatic amine compounds or that a monomeric diisocyanate is reacted with a plurality of aliphatic amine compounds. The reaction product of diphenylmethylene 4,4′-diisocyanate (MDI) with butylamine has proven particularly advantageous.

The urea derivative is preferably present in a carrier material. The carrier material can be a plasticizer, in particular a phthalate or an adipate, preferably a diisodecyl phthalate (DIDP) or dioctyl adipate (DOA). The carrier can also be a nondiffusing carrier. This is preferred in order to minimize migration of non-reacted constituents after hardening. Capped polyurethane prepolymers are preferred nondiffusing carriers.

The production of these preferred urea derivatives and of carrier materials is described in detail in the patent application EP 1 152 019 A1. The carrier material is advantageously a capped polyurethane prepolymer PU2, in particular obtained via reaction of a trifunctional polyether polyol with IPDI, followed by capping of the terminal isocyanate groups using ε-caprolactam.

The total proportion of the agent C having thixotropic effect is advantageously from 0 to 40% by weight, preferably from 5 to 25% by weight, based on the weight of the entire composition. The ratio of the weight of the urea derivative to the weight of any carrier present is preferably from 2/98 to 50/50, in particular from 5/95 to 25/75.

The heat-curing epoxy resin composition preferably further comprises a liquid rubber D, which is preferably a carboxy- or epoxide-terminated polymer.

In one first embodiment, this liquid rubber D is a carboxy- or epoxide-terminated acrylonitrile-butadiene copolymer, or a derivative thereof. Liquid rubbers of this type are commercially available by way of example as Hycar® CTBN and CTBNX and ETBN, from Nanoresins AG, Germany. Particularly suitable derivatives are elastomer-modified prepolymers having epoxide groups, examples being those marketed in the Polydis® product line, preferably in the Polydis® 36 . . . product line, from Struktol® (Schill+Seilacher Group, Germany), or in the Albipox product line (Nanoresins, Germany).

In a second embodiment, this liquid rubber D is an epoxide-terminated polyurethane prepolymer of the formula (XII) or, in another supply form, of the formula (XII′).

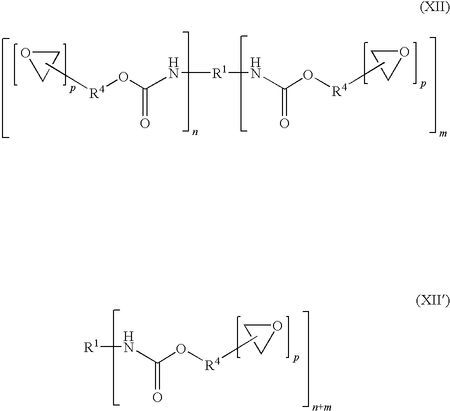

Many polyurethane prepolymers of this type capped with a single capping agent, i.e. capped symmetrically, are known from WO-A-2005/007720, in which they are termed polymer B of the formula (I). They are produced, as also described in detail in WO-A-2005/007720, from the polyurethane prepolymer PU1 which has the formula (III) and which contains isocyanate groups, and from an excess of the monohydroxyepoxide compound of the formula (V).

In a third embodiment, this liquid rubber D is a liquid polyacrylate rubber which is completely miscible with liquid epoxy resins and which demixes only during the hardening of the epoxy resin matrix, to give microdroplets. Liquid polyacrylate rubbers of this type are obtainable by way of example as 20208-XPA from Rohm and Haas.

It is naturally clear to the person skilled in the art that it is also possible to use mixtures of liquid rubbers, in particular mixtures of carboxy- or epoxide-terminated acrylonitrile/butadiene copolymers or derivatives thereof, using epoxide-terminated polyurethane prepolymers of the formula (XII).

The amount used of the liquid rubber D is advantageously from 1 to 35% by weight, in particular from 1 to 25% by weight, based on the weight of the composition.

The heat-curing epoxy resin composition preferably further comprises a solid toughener E. Here and hereinafter, a “toughener” is an additive which is used in an epoxy resin matrix and which, even when the amounts added are small, from 0.1 to 15% by weight, in particular from 0.5 to 8% by weight, brings about a marked increase in toughness, thus permitting absorption of higher flexural, tensile, or impact stresses before the matrix tears or fractures.

In one first embodiment, the solid toughener E is an organic ion-exchanged laminar mineral E1.

The ion-exchanged laminar mineral E1 can be either a cation-exchanged laminar mineral E1c or an anion-exchanged laminar mineral E1a.

The cation-exchanged laminar mineral E1c here is obtained from a laminar mineral E1′ in which at least a portion of the cations have been exchanged for organic cations. Examples of these cation-exchanged laminar minerals E1c are in particular those mentioned in U.S. Pat. No. 5,707,439 or U.S. Pat. No. 6,197,849. Those documents also describe the process for the production of these cation-exchanged laminar minerals E1c. A phyllosilicate is preferred as laminar mineral E1′. The laminar mineral E1′ particularly preferably involves a phyllosilicate described in U.S. Pat. No. 6,197,849, column 2, line 38 to column 3, line 5, and particularly involves a bentonite. Laminar minerals E1′ such as kaolinite, or a montmorillonite, or a hectorite, or an illite have proven to be particularly suitable.

At least a portion of the cations of the laminar mineral E1′ is replaced by organic cations. Examples of cations of this type are n-octylammonium, trimethyldodecylammonium, dimethyldodecylammonium, or bis(hydroxyethyl)octadecylammonium, or similar derivatives of amines which can be obtained from naturally occurring fats and oils; or guanidinium cations, or amidinium cations; or cations of the N-substituted derivatives of pyrrolidine, piperidine, piperazine, morpholine, thiomorpholine; or cations of 1,4-diazobicyclo[2.2.2]octane (DABCO) and 1-azobicyclo[2.2.2]octane; or cations of N-substituted derivatives of pyridine, pyrrole, imidazole, oxazole, pyrimidine, quinoline, isoquinoline, pyrazine, indole, benzimidazole, benzoxazole, thiazole, phenazine and 2,2′-bipyridine. Other suitable cations are cyclic amidinium cations, in particular those disclosed in U.S. Pat. No. 6,197,849 in column 3, line 6 to column 4, line 67. Cyclic ammonium compounds feature increased thermal stability in comparison with linear ammonium compounds, since they cannot undergo thermal Hoffmann degradation.

Preferred cation-exchanged laminar minerals E1c are known to the person skilled in the art by the term organoclay or nanoclay, and are commercially available by way of example within the product groups Tixogel® or Nanofil® (Südchemie), Cloisite® (Southern Clay Products) or Nanomer® (Nanocor Inc.).

The anion-exchanged laminar mineral E1a here is obtained from a laminar mineral E1″ in which at least a portion of the anions has been exchanged for organic anions. Examples of this type of anion-exchanged laminar mineral E1a is a hydrotalcite E1″ in which at least a portion of the carbonate anions of the intermediate layers has been exchanged for organic anions. A further example is provided by functionalized aluminoxanes, as described by way of example in U.S. Pat. No. 6,322,890.

It is certainly also possible that the composition simultaneously comprises a cation-exchanged laminar mineral E1 C and an anion-exchanged laminar mineral E1a.

In a second embodiment, the solid toughener is a block copolymer E2. The block copolymer E2 is obtained from an anionic or controlled free-radical polymerization reaction of methacrylic ester with at least one further monomer having an olefinic double bond. Monomers particularly preferred as those having an olefinic double bond are those in which the double bond has direct conjugation with a heteroatom or with at least one further double bond. Particularly suitable monomers are those selected from the group consisting of styrene, butadiene, acrylonitrile, and vinyl acetate. Preference is given to acrylate-styrene-acrylic acid (ASA, obtainable by way of example as GELOY 1020 from GE Plastics.

Particularly preferred block copolymers E2 are block copolymers composed of methyl methacrylate, styrene, and butadiene. Block copolymers of this type are obtainable by way of example in the form of triblock copolymers in the SBM product group from Arkema.

In a third embodiment, the solid toughener E is a core-shell polymer E3. Core-shell polymers are composed of an elastic core polymer and of a rigid shell polymer. Core-shell polymers that are particularly suitable are composed of a core of elastic acrylate polymer or of elastic butadiene polymer, with a surrounding rigid shell of a rigid thermoplastic polymer. This core-shell structure either forms spontaneously via demixing of a block copolymer, or is the inevitable result of using a latex or suspension-polymerization method for the polymerization reaction, with subsequent grafting. Preferred core-shell polymers are those known as MBS polymers, which are available commercially as Clearstrength™ from Atofina, Paraloid™ from Rohm and Haas, or F-351™ from Zeon.

Particular preference is given to core-shell polymer particles present in the form of dried polymer latex. Examples of these are GENIOPERL M23A from Wacker having polysiloxane core and acrylate shell, radiation-crosslinked rubber particles from the NEP line, produced by Eliokem, or Nanoprene from Lanxess, or Paraloid EXL from Rohm and Haas.

Other comparable examples of core-shell polymers are supplied as Albidur™ from Nanoresins AG, Germany.

In a fourth embodiment, the solid toughener E is a solid reaction product E4 of a carboxylated solid nitrile rubber with excess epoxy resin.

Core-shell polymers are preferred as solid toughener E.

The heat-curing epoxy resin composition can in particular comprise an amount of from 0.1 to 15% by weight, preferably from 1 to 8% by weight, based on the weight of the composition, of the solid core-shell polymer E3.

In another preferred embodiment, the composition also comprises at least one filler F. This preferably involves mica, talc, kaolin, wollastonite, feldspar, syenite, chlorite, bentonite, montmorillonite, calcium carbonate (precipitated or ground), dolomite, quartz, silicas (fumed or precipitated), cristobalite, calcium oxide, aluminum hydroxide, magnesium oxide, hollow ceramic beads, hollow or solid glass beads, hollow organic beads, or color pigments. Filler F means both the organically coated and the uncoated forms which are commercially available and known to the person skilled in the art.

The total proportion of the entire filler F is advantageously from 3 to 50% by weight, preferably from 5 to 35% by weight, in particular from 5 to 25% by weight, based on the weight of the entire composition.

In another preferred embodiment, the composition comprises a physical or chemical blowing agent, for example one available with trademark Expancel™ from Akzo Nobel or Celogen™ from Chemtura. The proportion of the blowing agent is advantageously from 0.1 to 3% by weight, based on the weight of the composition.

In another preferred embodiment, the composition also comprises at least one reactive diluent G bearing epoxide groups. These reactive diluents G in particular involve:
glycidyl ethers of monohydric saturated or unsaturated, branched or unbranched, cyclic or open-chain C₄-C₃₀ alcohols, e.g. butanol glycidyl ether, hexanol glycidyl ether, 2-ethylhexanol glycidyl ether, allyl glycidyl ether, tetrahydrofurfuryl glycidyl ether, and furfuryl glycidyl ether, trimethoxysilyl glycidyl ether, etc.,
glycidyl ethers of dihydric saturated or unsaturated, branched or unbranched, cyclic or open-chain C₂-C₃₀ alcohols, e.g. ethylene glycol glycidyl ether, butanediol glycidyl ether, hexanediol glycidyl ether, octanediol glycidyl ether, cyclohexanedimethanol diglycidyl ether, neopentyl glycol diglycidyl ether, etc.,
glycidyl ethers of tri- or polyhydric, saturated or unsatured, branched or unbranched, cyclic or open-chain alcohols, e.g. epoxidized castor oil, epoxidized trimethylolpropane, epoxidized pentaerythritol, or polyglycidyl ethers of aliphatic polyols, such as sorbitol, glycerol, trimethylolpropane, etc.,
glycidyl ethers of phenol compounds and of aniline compounds, e.g. phenyl glycidyl ether, cresyl glycidyl ether, p-tert-butylphenyl glycidyl ether, nonylphenol glycidyl ether, 3-n-pentadecenyl glycidyl ether (from cashew nut shell oil), N,N-diglycidylaniline, etc.,
epoxidized amines, such as N,N-diglycidylcyclohexylamine, etc.,
epoxidized mono- or dicarboxylic acids, e.g. glycidyl neodecanoate, glycidyl methacrylate, glycidyl benzoate, diglycidyl phthalate, diglycidyl tetrahydrophthalate, diglycidyl hexahydrophthalate, diglycidyl esters of dimeric fatty acids, etc.,
epoxidized di- or trihydric, low- to high-molecular-weight polyether polyols, e.g. polyethylene glycol diglycidyl ether, polypropylene glycol diglycidyl ether, etc.

Particular preference is given to hexanediol diglycidyl ether, cresyl glycidyl ether, p-tert-butylphenyl glycidyl ether, polypropylene glycol diglycidyl ether, and polyethylene glycol diglycidyl ether.

The total proportion of the reactive diluent G bearing epoxide groups is advantageously from 0.5 to 20% by weight, preferably from 1 to 8% by weight, based on the weight of the entire composition.

The composition can encompass further constituents, in particular catalysts, heat stabilizers and/or light stabilizers, agents with thixotropic effects, plasticizers, solvents, mineral or organic fillers, blowing agents, dyes, and pigments.

It has been found that the heat-curing epoxy resin compositions described are particularly suitable as single-component adhesives. This type of single-component adhesive has a wide range of possible applications. In particular, it is possible here to realize heat-curing single-component adhesives which feature high impact resistance, not only at relatively high temperatures but also particularly at low temperatures, in particular at from 0° C. to −40° C. Adhesives of this type are needed for the adhesive bonding of heat-resistant materials. Heat-resistant materials are materials which are dimensionally stable at a hardening temperature of from 100 to 220° C., preferably from 120 to 200° C., at least during the hardening time. These materials in particular involve metals and plastics such as ABS, polyamide, polyphenylene ether, composite materials, such as SMC, unsaturated GF-reinforced polyesters, and epoxy composite materials or acrylate composite materials. Preference is given to the application in which at least one material is a metal. A particularly preferred application is the adhesive bonding of identical or different metals, in particular in bodyshell construction in the automobile industry. The preferred metals are particularly steel, in particular electrolytically galvanized or hot-dip galvanized or oiled steel, or Bonazinc-coated steel, and subsequently phosphated steel, and also aluminum, in particular in the variants occurring typically in automobile construction.

An adhesive based on a heat-curing composition of the invention permits achievement of the desired combination of high crash strength together with both high and low usage temperature.

This adhesive is first brought into contact at a temperature of from 10° C. to 80° C., in particular from 10° C. to 60° C., with the materials to be adhesively bonded, and then hardened at a temperature which is typically from 100 to 220° C., preferably from 120 to 200° C.

This process for the adhesive bonding of heat-resistant materials gives an adhesive-bonded item. This item is preferably a vehicle or an add-on part of a vehicle.

A composition of the invention can, of course, be used to realize not only heat-curing adhesives but also sealing compositions or coatings. The compositions of the invention are moreover suitable not only for automobile construction but also for other application sectors. Particular mention may be made of related applications in the construction of means of conveyance such as ships, trucks, buses, or rail vehicles, or in the construction of consumer goods, such as washing machines.

The materials adhesive-bonded by means of a composition of the invention are used at temperatures which are typically from 120° C. to −40° C., preferably from 100° C. to −40° C., in particular from 80° C. to −40° C.

It is possible to formulate compositions which typically have fracture energies to ISO 11343 of more than 10.0 J at 23° C. and more than 9.0 J at −30° C., and/or of more than 8.0 J at −40° C. It is sometimes possible to formulate compositions which have fracture energies of more than 13.0 J at 23° C. and of more than 10.0 J at −30° C., and/or of more than 9.0 J at −40° C. Indeed, particularly advantageous compositions have fracture energies of more than 14.0 J at 23° C. and of more than 11.0 J at −30° C., and/or of more than 10.0 J at −40° C.

One particularly preferred application of the heat-curing epoxy resin composition of the invention is the application as heat-curing bodyshell adhesive in vehicle construction.

### EXAMPLES

Some examples will be indicated below, providing further illustration of the invention, but not in any way intended to restrict its scope. The raw materials used in the examples are listed in table 1.

TABLE 1
Raw materials used.

| Raw materials used | Supplier |
|---|---|
| D.E.R. ™ 330 (bisphenol A diglycidyl ether = | Dow |
| “DGEBA”) | |
| D.E.R. 671 (“type 1” solid resin) (EP- | Dow |
| equivalent weight 475-550 g/eq) | |
| Struktol ® Polydis ® VP-3611 (bisphenol F | Schill & |
| diglycidyl ether, modifier nitrile- | Seilacher |
| butadiene rubber) (EEW = 560 g/val)) | |
| (=“Polydis”) | |
| Araldite ® DY-H (hexanediol diglycidyl | Huntsman |
| ether) (=“DY-H”) | |
| Dicyandiamide (=“dicy”) | Degussa |
| Poly-THF 2000 (difunctional polybutylene | BASF |
| glycol) (OH-equivalent weight = about 1000 | |
| g/OH-equivalent) | |
| Desmophen 3060 BS (trifunctional | Bayer |
| polypropylene glycol) (OH-equivalent | |
| weight = 1000 g/OH-equivalent) | |
| Isophorone diisocyanate (=IPDI) | Degussa- |
| | Hüls |
| Diphenylmethylene 4,4′-diisocyanate | Bayer |
| (=MDI) | |
| N-Butylamine | BASF |
| ε-Caprolactam | EMS Chemie |
| Cardolite NC-700 (Cardanol) (=“NC”) | Cardolite |
| 2,2′-Diallylbisphenol A (=“DABPA”) | Sigma- |
| | Aldrich |
| 2-Hydroxybenzyl alcohol (=“HBA”) | Sigma- |
| | Aldrich |

### Example of Production of a Monohydroxylated Epoxide “M1”

Trimethylolpropane glycidyl ether was produced by the process in U.S. Pat. No. 5,668,227, example 1, starting from trimethylolpropane and epichlorohydrin, using tetramethylammonium chloride and sodium hydroxide solution. The product is yellowish, with an epoxy number of 7.5 eq/kg and with hydroxy group content of 1.8 eq/kg. The HPLC MS spectrum indicates that it is in essence a mixture of trimethylolpropane diglycidyl ether and trimethylolpropane triglycidyl ether. This product was used as M1 in table 2.

### Monohydroxylated Epoxide “M2”

1,3-Bis(4-(2-(4-(oxiran-2-ylmethoxy)phenyl)propan-2-yl)phenoxy)propan-2-ol) (“DGEBA dimer”):

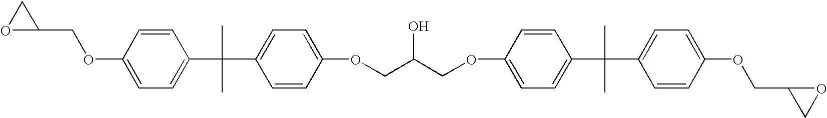

corresponding to the compound of the formula (IX) in which R is methyl. 1,3-Bis(4-(2-(4-(oxiran-2-ylmethoxy)phenyl)propan-2-yl)phenoxy)propan-2-ol) was obtained from technical-grade bisphenol A diglycidyl ether (DGEBA) (Araldite® GY 250, produced by Huntsman), in which it is present to an extent of about 15% by weight. It can be concentrated by distillative removal of DGEBA. Technical-grade bisphenol A diglycidyl ether (EEW=195 g/epoxide-equivalent, determined via titration) is metered at a heating-jacket temperature of 180° C., under the vacuum generated by an oil pump, at 200 ml/h by a membrane pump into a thin-film evaporator (produced by Ilmag). Pure DGEBA is removed by distillation in this process and crystallizes at room temperature. The bottom product remaining has EEW=207.1 g/epoxide-equivalent. Using THF as solvent, the GPC plot shows a 40:60 ratio of the areas of the peaks of “DGEBA dimer” and DGEBA. This product was used as “M2” in table 2.

### Examples of the Production of Isocyanate-Terminated Polyurethane Prepolymers

### PU1-1

200.00 g of Desmophen 3060 BS (OH number: 57.0 mg/g of KOH) were dried at 110° C. in vacuo for 30 minutes. Once the temperature had been reduced to 90° C., 47.55 g of IPDI and 25 mg of dibutyltin dilaurate were added. The reaction was conducted in vacuo at 90° C. until NCO content was constant at 3.64%, after 2.5 h (theoretical NCO content: 3.73%).

### PU1-2

200.00 g of PolyTHF 2000 (OH number: 57.0 mg/g of KOH) were dried at 110° C. in vacuo for 30 minutes. Once the temperature had been reduced to 90° C., 48.0 g of IPDI and 25 mg of dibutyltin dilaurate were added. The reaction was conducted in vacuo at 90° C. until NCO content was constant at 3.65%, after 2.5 h (theoretical NCO content: 3.76%).

### Example of an End-Capped Polyurethane Prepolymer of the Formula (I)

By way of example, the preparation of the polymer P2 is described here in detail:

65.5 g of the monohydroxylated epoxide M1 described above were now added to the 247.6 g of the isocyanate-terminated polyurethane prepolymer PU1-1 produced above, and, in molar terms, half of the terminal isocyanates of the polymer were thus consumed in the reaction. The product was stirred in vacuo at 90° C. until NCO content had fallen to about 1.4%, after a further 2 hours. 38.6 g of cardanol were then added (hydroxy content: about 3.33 eq/kg).

A clear product was obtained with epoxide content (“end content”) of 1.39 eq/kg and with NCO content of <0.05%.

The other capped polyurethane prepolymers described in table 2 were produced analogously. In the case of the capped polyurethane polymers P1, P2, P3, P-R1, and P-R2, the amount used of monohydroxylated epoxide (M1) and cardanol (NC) was varied. The capped polyurethane polymers P4, P5, and P6 differed from P2 in that the monohydroxylated epoxide M2, or a mixture of M1 and M2, was used. PU1-2 was used as polyurethane prepolymer for the capped polyurethane polymers P7, P8, P-R3, P-R4, and P-R5, and other capping agents were used. In P7, P-R3, and P-R4, the amount of M1 and of 2,2′-diallyl bisphenol A (DABPA) was varied, and in P8 and P-R5 the amount of M1 and of 2-hydroxybenzyl alcohol (HBA) was varied.

The polymers P-R1, P-R2, P-R3, P-R4, and P-R5 have only one capping agent and are therefore “symmetrically capped” polymers.

TABLE 2
Production of capped polyurethane prepolymers.

| | P-R1 | P1 | P2 | P3 | P-R2 | P4 | P5 | P6 | P-R3 | P7 | P-R4 | P8 | P-R5 |
|---|---|---|---|---|---|---|---|---|---|---|---|---|---|
| PU1-1 [g] | 247.6 | 247.6 | 247.6 | 247.6 | 247.6 | 247.6 | 247.6 | 247.6 | | | | | |
| PU1-2 [g] | | | | | | | | | 248.0 | 248.0 | 248.0 | 248.0 | 248.0 |
| M1 [g] | 131.0 | 117.9 | 65.5 | 26.2 | | 39.7 | 19.9 | | 131.6 | 65.8 | | 12.0 | 0 |
| M1 (%)¹ | 100 | 90 | 50 | 20 | 0 | 33 | 17 | 0 | 100 | 50 | 0 | 10 | 0 |
| M2 [g] | | | | | | 71.5 | 143.0 | 214.4 | | | | | |
| M2 (%)¹ | | | | | | 17 | 33 | 50 | | | | | |
| DABPA [g] | | | | | | | | | 0 | 37.3 | 78.6 | | |
| DABPA (%)¹ | | | | | | | | | 0 | 50 | 100 | | |
| NC [g] | | 7.8 | 38.6 | 61.8 | 77.3 | 38.6 | 38.6 | 38.6 | | | | | |
| NC (%)¹ | 0 | 10 | 50 | 80 | 100 | 50 | 50 | 50 | | | | | |
| HBA [g] | | | | | | | | | | | | 26.6 | 29.0 |
| HBA (%)¹ | | | | | | | | | | | | 90 | 100 |

¹mol % of NCO groups capped with this capping agent in polyurethane prepolymer PU1-1 and, respectively, PU1-2.

Agent C with Thixotropic Effect

As an example of an agent C with thixotropic effect, based on a urea derivative in a nondiffusing carrier material, an agent C of patent application EP 1 152 019 A1 was produced in a capped polyurethane prepolymer, using abovementioned raw materials:

Carrier Material: Capped Polyurethane Prepolymer “blockPU”

600.0 g of a polyether polyol (Desmophen 3060BS; 3000 daltons; OH number 57 mg/g of KOH) were reacted at 90° C. in vacuo, with stirring, with 140.0 g of IPDI and 0.10 g of dibutyltin dilaurate, to give the isocyanate-terminated prepolymer. The reaction was conducted to constant NCO content of 3.41% after 2.5 h (theoretical NCO content: 3.60%). The free isocyanate groups were then capped at 90° C. in vacuo with 69.2 g of ε-caprolactam (2% excess), achieving an NCO content of <0.1% after 3 h.

### Urea Derivative (“UD”) in Capped Polyurethane Prepolymer:

68.7 g of MDI flakes were melted, under nitrogen and with gentle heating, in 181.3 g of the capped prepolymer “blockPU” described above. 40.1 g of n-butylamine dissolved in 219.9 g of the capped prepolymer “blockPU” described above were then added dropwise, under nitrogen and with rapid stirring, during a period of two hours. Once the addition of the amine solution had ended, the white paste was stirred for a further 30 minutes. After cooling, this gave a soft white paste, the free isocyanate content of which was <0.1% (proportion of urea derivative about 21%).

### Production of the Compositions

As shown in table 3, the reference compositions Ref. 1 to Ref. 5 and the compositions 1 to 8 of the invention were produced.

### Test Methods:

### Tensile Shear Strength (TSS) (DIN EN 1465)

The test specimens were produced from the example compositions described, and using electrolytically galvanized DC04 steel (eloZn) with dimensions 100×25×1.5 mm and, respectively, 100×25×0.8 mm, the adhesive area being 25×10 mm, with layer thickness 0.3 mm. Curing was carried out for 30 min. at 180° C. The tensile testing rate was 10 mm/min.

### Tensile Strength (TS) (DIN EN ISO 527)

A specimen of adhesive was pressed to a layer thickness of 2 mm between two Teflon papers. The adhesive was then cured for 30 minutes at 180° C. The Teflon papers were removed, and the test specimens in accordance with the DIN standard were stamped out while hot. The test specimens were stored for 1 day under standard conditions of temperature and humidity and then tested using a tensile testing rate of 2 mm/min.

Tensile strength was determined to DIN EN ISO 527.

### Cleavage Under Dynamic Load (ISO 11343)

The test specimens were produced from the compositions of the examples described, using electrolytically galvanized DC04 steel (eloZn) with dimensions 90×20×0.8 mm, the adhesive area being 20×30 mm, with a layer thickness of 0.3 mm. They were cured at 180° C. for 30 min. Cleavage under dynamic load was in each case measured at room temperature, at −20° C. and at −40° C. and, respectively, −30° C. The dynamic rate was 2 m/s. The area under the test curve (from 25% to 90%, to ISO 11343) is stated as fracture energy (FE) in joules.

Table 3 collates the results of these tests.

TABLE 3
Constitutions of heat-curing compositions and
results.

| | Ref. 1 | 1 | 2 | 3 | Ref. 2 | 4 | 5 | 6 | Ref. 3 | 7 | Ref. 4 | 8 | Ref. 5 |
|---|---|---|---|---|---|---|---|---|---|---|---|---|---|
| D.E.R.671(A) [g] | 15.0 | 15.0 | 15.0 | 15.0 | 15.0 | 15.0 | 15.0 | 15.0 | 18.0 | 18.0 | 18.0 | 18.0 | 18.0 |
| DGEBA (A) [g] | 30.0 | 30.0 | 30.0 | 30.0 | 30.0 | 27.0 | 24.0 | 20.0 | 37.0 | 37.0 | 37.0 | 37.0 | 37.0 |
| DY-H (G) [g] | 3.0 | 3.0 | 3.0 | 3.0 | 3.0 | 3.0 | 3.0 | 3.0 | 3.0 | 3.0 | 3.0 | 3.0 | 3.0 |
| M1 (G) [g] | | 0.5 | 3.0 | 5.0 | 6.0 | 4.0 | 5.0 | 6.0 | | 4.5 | 8.5 | 7.0 | 8.5 |
| Polydis (D) [g] | 10.0 | 10.0 | 10.0 | 10.0 | 10.0 | 10.0 | 10.0 | 10.0 | | | | | |
| P-R1 [g] | 20.0 | | | | | | | | | | | | |
| P1 [g] | | 19.5 | | | | | | | | | | | |
| P2 [g] | | | 17.0 | | | | | | | | | | |
| P3 [g] | | | | 15.0 | | | | | | | | | |
| P-R2 [g] | | | | | 14.0 | | | | | | | | |
| P4 [g] | | | | | | 19.5 | | | | | | | |
| P5 [g] | | | | | | | 21.5 | | | | | | |
| P6 [g] | | | | | | | | 24.5 | | | | | |
| P-R3 [g] | | | | | | | | | 25.0 | | | | |
| P7 [g] | | | | | | | | | | 22.5 | | | |
| P-R4 [g] | | | | | | | | | | | 21.5 | | |
| P8 [g] | | | | | | | | | | | | 22.0 | |
| P-R5 [g] | | | | | | | | | | | | | 21.5 |
| UD (C) [(g] | 3.0 | 3.0 | 3.0 | 3.0 | 3.0 | 3.0 | 3.0 | 3.0 | 4.0 | 4.0 | 4.0 | 4.0 | 4.0 |
| blockPU [g] | 10.0 | 10.0 | 10.0 | 10.0 | 10.0 | 10.0 | 10.0 | 10.0 | 16.0 | 16.0 | 16.0 | 16.0 | 16.0 |
| dicy (D) [g] | 4.4 | 4.4 | 4.4 | 4.4 | 4.4 | 4.4 | 4.4 | 4.4 | 5.0 | 5.0 | 5.0 | 5.0 | 5.0 |
| Filler mixture | 12.0 | 12.0 | 12.0 | 12.0 | 12.0 | 12.0 | 12.0 | 12.0 | 14.0 | 14.0 | 14.0 | 14.0 | 14.0 |
| (F) [g] | | | | | | | | | | | | | |
| TS [MPa] | 30.4 | 30.9 | 29.8 | 31 | 29.9 | 31.9 | 32.2 | 31.4 | 34.0 | 29.8 | 26.0 | 25.7 | 24.4 |
| TSS_{1.5 mm} [MPa] | 37.6 | 39.7 | 39.6 | 37.5 | 38.8 | 34.0 | 36.0 | 32.3 | n.m.² | n.m.² | n.m.² | n.m.² | n.m.² |
| TSS0_{0.8 mm} [MPa] | n.m.² | n.m.² | n.m.² | n.m.² | n.m.² | n.m.² | n.m.² | n.m.² | 21.6 | 23.6 | 23.0 | 22.4 | 20.2 |
| FE¹ at 23° C. [J] | 13.2 | 13.6 | 15.3 | 15.5 | 14.7 | 14.9 | 14.9 | 14.7 | 11.9 | 15.7 | 12.6 | 16.3 | 14.8 |
| FE¹ at −20° C. [J] | n.m.² | n.m.² | n.m.² | n.m.² | n.m.² | n.m.² | n.m.² | n.m.² | 11.2 | 14.4 | 10.0 | 15.8 | 14.8 |
| FE¹ at −30° C. [J] | 9.6 | 10.3 | 11.4 | 10.1 | 5.8 | 12.0 | 11.7 | 11.6 | n.m.² | n.m.² | n.m.² | n.m.² | n.m.² |
| FE¹ at −40° C. [J] | n.m.² | n.m.² | n.m.² | n.m.² | n.m.² | n.m.² | n.m.² | n.m.² | 9.6 | 13.5 | 4.5 | 14.0 | 12.9 |

¹FE = fracture energy.
²n.m. = not measured.

1. An end-capped polyurethane prepolymer of the formula (I) 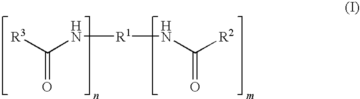
where
R¹ is a linear or branched polyurethane prepolymer PU1 terminated by n+m isocyanate groups, after removal of all of the terminal isocyanate groups;
each R², independently of the others, is a capping group which cleaves at a temperature above 100° C., or is a group of the formula (II) 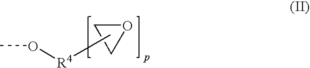
each R³, independently of the others, is a capping group which cleaves at a temperature above 100° C., or is a group of the formula (II′) 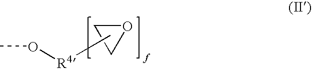
where in each case R⁴ and R^{4′} is a moiety of an aliphatic, cycloaliphatic, aromatic, or araliphatic epoxide containing a primary or secondary hydroxy group, after the removal of the hydroxide and epoxide groups;
p=1, 2, or 3, and f=1, 2, or 3;
each of n and m is a value from 1 to 7, with the proviso that 2≦(m+n)≦8, and that R² differs from R³.

2. The end-capped polyurethane prepolymer of the formula (I), where R² and/or R³ is a moiety selected from the group consisting of 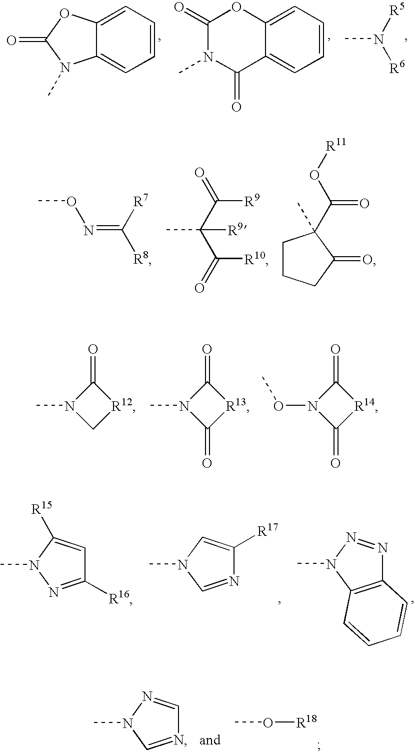
where
in each case R⁵, R⁶, R⁷ and R⁸, independently of the others, is an alkyl or cycloalkyl or aryl or aralkyl or arylalkyl group,
or R⁵ together with R⁶, or R⁷ together with R⁸, forms a portion of an optionally substituted 4- to 7-membered ring;
in each case R⁹, R^{9′}, and R¹⁰, independently of the others, is an alkyl or aralkyl or aryl or arylalkyl group, or is an alkyloxy or aryloxy or aralkyloxy group;
R¹¹ is an alkyl group,
in each case R¹², R¹³, and R¹⁴, independently of the others, is an alkylene group having from 2 to 5 carbon atoms and, if appropriate, having double bonds or substitution, or is a phenylene group, or is a hydrogenated phenylene group;
in each case R¹⁵, R¹⁶, and R¹⁷, independently of the others, is H, or is an alkyl group, or is an aryl group or an aralkyl group; and
R¹⁸ is an aralkyl group or is a mono- or polynuclear substituted or unsubstituted aromatic group which, if appropriate, has aromatic hydroxy groups.

3. The end-capped polyurethane prepolymer as claimed in claim 1, wherein R² is a group of the formula (II).

4. The end-capped polyurethane prepolymer as claimed in claim 1, wherein the polyurethane prepolymer PU1 is produced from at least one diisocyanate or triisocyanate, and also
from a polymer Q_{PM} having terminal amino, thiol, or hydroxy groups;
and/or
from a polyphenol Q_{PP} which if appropriate has substitution.

5. The end-capped polyurethane prepolymer as claimed in claim 4, wherein the polymer Q_{PM} has 2 or 3 terminal amino, thiol, or hydroxy groups.

6. The end-capped polyurethane prepolymer as claimed in claim 4, wherein the polymer Q_{PM} is an α,ω-dihydroxypolyalkylene glycol having C₂-C₆-alkylene groups or having mixed C₂-C₆-alkylene groups, and having termination by amino, thiol, or, preferably, hydroxy groups.

7. The end-capped polyurethane prepolymer as claimed in claim 4, wherein the polymer Q_{PM} is a hydroxylated polybutadiene or polyisoprene, or a partially or completely hydrogenated reaction product thereof.

8. The end-capped polyurethane prepolymer as claimed in claim 4, wherein the polymer Q_{PM} has an OH-equivalent weight of from 300 to 6000 g/OH-equivalent, in particular from 700 to 2200 g/OH-equivalent.

9. The end-capped polyurethane prepolymer as claimed in claim 4, wherein the polyphenol Q_{PP} has 2 or 3 phenolic groups.

10. The end-capped polyurethane prepolymer as claimed in claim 4, wherein the diisocyanate or triisocyanate used for the production of the polyurethane prepolymer PU1 is a diisocyanate.

11. A heat-curable epoxy resin composition comprising:
at least one epoxy resin A having an average of more than one epoxide group per molecule;
at least one end-capped polyurethane prepolymer of the formula (I) as claimed in claim 1,
at least one hardener B for epoxy resins, where this hardener is activated via an elevated temperature.

12. The heat-curing epoxy resin composition as claimed in claim 11, the composition further comprising at least one agent C with thixotropic effect, based on urea derivative in a carrier material based on the weight of the composition.

13. The heat-curing epoxy resin composition as claimed in claim 11, the composition further comprising a liquid rubber D based on the weight of the composition.

14. The heat-curing epoxy resin composition as claimed in claim 11, the composition further comprising a solid toughener E, in particular in an amount of from 0.1 to 15% by weight, in particular from 0.5 to 8% by weight, based on the weight of the composition.

15. The heat-curing epoxy resin composition as claimed in claim 14, wherein the solid toughener E is a core-shell polymer.

16. The heat-curing epoxy resin composition as claimed in claim 11, the composition further comprising at least one filler F based on the weight of the composition.

17. The heat-curing epoxy resin composition as claimed in claim 11, the composition further comprising a reactive diluent G bearing epoxide groups based on the weight of the composition.

18. The heat-curing epoxy resin composition as claimed in claim 11, the epoxy resin composition further comprising at least one blowing agent based on the weight of the composition.

19. The heat-curing epoxy resin composition as claimed in claim 11, wherein the proportion of the epoxy resin A is from 10 to 85% by weight based on the weight of the composition.

20. The heat-curing epoxy resin composition as claimed in claim 11, wherein the proportion of the end-capped polyurethane prepolymer of the formula (I) is from 1 to 45% by weight based on the weight of the composition.

21. A method of improving the strength of adhesives subject to impact forces, the method comprising:
providing the end-capped polyurethane prepolymer of the formula (I) as claimed in claim 1.

22. A process for the production of a heat-curing epoxy resin composition as claimed in claim 11, wherein the end-capped polyurethane prepolymer of the formula (I) results from a sequential reaction, where, in a first step, a partially capped polyurethane prepolymer of the formula (IVa) or (UVb) is formed from the linear or branched polyurethane prepolymer PU1 terminated by isocyanate groups and from the compound R²H or, respectively, R³H; 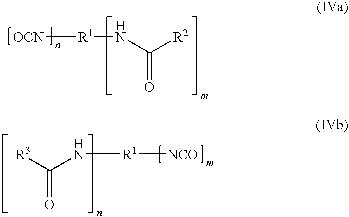
and then, in the second step, this intermediate of the formula (IVa) containing NCO groups is reacted with R³H, or, respectively, this intermediate of the formula (IVb) containing NCO groups is reacted with R²H, to give the end-capped polyurethane prepolymer of the formula (I).

23. The process as claimed in claim 22, wherein the production of the end-capped polyurethane prepolymer of the formula (I) takes place separately and said prepolymer is added during the production of the composition.

24. The process as claimed in claim 23, wherein a semifinished product is first produced which comprises the partially capped polyurethane prepolymer of the formula (IVa) or (IVb), and the second step takes place at a later juncture, by admixing the compound R³H or, respectively, the compound R²H, with the semifinished product.

25. A method of heat curing, the method comprising:
providing the heat-curing epoxy resin composition as claimed in claim 11, wherein the heat-curing epoxy resin composition is a single-component heat-curing adhesive.

26. A process for the adhesive bonding of heat-resistant materials, wherein these materials are brought into contact with a heat-curing epoxy resin composition as claimed in claim 11, and the process encompasses one or more steps of hardening at a temperature of from 100 to 220° C.

27. The process for adhesive bonding as claimed in claim 26, wherein the materials are brought into contact with a heat-curing epoxy resin composition comprising:
at least one epoxy resin A having an average of more than one epoxide group per molecule;
at least one end-capped polyurethane prepolymer of the formula (I) 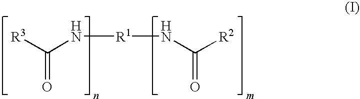
where
R¹ is a linear or branched polyurethane prepolymer PU1 terminated by n+m isocyanate groups, after removal of all of the terminal isocyanate groups;
each R², independently of the others, is a capping group which cleaves at a temperature above 100° C., or is a group of the formula (II) 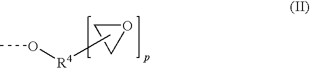
each R³, independently of the others, is a capping group which cleaves at a temperature above 100° C., or is a group of the formula (II′) 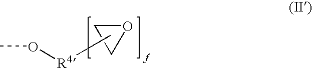
where in each case R⁴ and R^{4′} is a moiety of an aliphatic, cycloaliphatic, aromatic, or araliphatic epoxide containing a primary or secondary hydroxy group, after the removal of the hydroxide and epoxide groups;
p=1, 2, or 3, and f=1, 2, or 3;
each of n and m is a value from 1 to 7, with the proviso that 2≦(m+n)≦8, and that R² differs from R³;
at least one hardener B for epoxy resins, where this hardener is activated via an elevated temperature;
and, after the adhesive bonding, the adhesive-bonded materials are used at temperatures of from 120° C. to −40° C.

28. An adhesive-bonded item which is obtained via a process as claimed in claim 26.

29. The adhesive-bonded item as claimed in claim 28, which is a vehicle or an add-on part of a vehicle.
